(19) United States
(12) Patent Application Publication
(10) Pub. No.: US 2003/0069802 A1
(43) Pub. Date: Apr. 10, 2003

(54) Tv shopping monitor and notification system

(75) Inventor: Carolyn Christine Ramsey-Catan, Pleasantville, NY (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/973,356

(22) Filed: Oct. 9, 2001

(51) Int. Cl. G06F 17/60

(52) U.S. Cl. 705/26

(57) ABSTRACT

A remote purchase controller for a remote purchase electronic payment account has absolute or periodic limits associated with one or more authorized account users. When a remote purchase transaction would exceed the available limit for a requesting user, including any associated over-draft margin, some form of override of the limit is sought, such as by direct override approval or by allocation of at least a portion of the remote purchase transaction amount against another user's limit. If the limit remains, the remote purchase transaction is held until the beginning of a next period, when the transaction may be either automatically executed or submitted for reapproval by the requesting user.

### TECHNICAL FIELD OF THE INVENTION

The present invention is directed, in general, to remote purchasing and, more specifically, to monitoring and limiting remote purchases over one or more communications systems.

### BACKGROUND OF THE INVENTION

Contemporary “home shopping” systems, which present items for sale to users either in a television broadcast or over the Internet, allow users to purchase items utilizing credit cards and similar electronic payment systems to complete the transaction. For purchases of items offered for sale via either television or the Internet, the purchaser may telephone a call center to provide credit card or other account information and authorize payment. Alternatively, for items offered for sale via the Internet or other interactive systems, the purchaser may enter the credit card or account number for electronic transmission to a processing facility. Security provided by the processing facility protects the confidentiality of the account information.

Some users may wish to track or otherwise monitor their “remote” purchases (i.e., purchases via the Internet or from television broadcasts) For example, some users may be uncomfortable with impulse purchases being extremely easy to complete, or may wish to restrict or limit purchases by a particular authorized purchaser such as a son, daughter or other family member. Even if all vendors from which the user makes remote purchases provide purchase histories, the user must identify transactions from all vendors during a relevant period and manually total them. The relevant spending information for a given period is not easily accessible by the user for review in a straightforward or simple manner. Additionally, the limits or restrictions desired by the user cannot be enforced.

There is, therefore, a need in the art for a system enabling tracking and control over remote purchases via one or more communications systems.

### SUMMARY OF THE INVENTION

To address the above-discussed deficiencies of the prior art, it is a primary object of the present invention to provide, for use in communications network, a remote purchase controller for a remote purchase electronic payment account which has absolute or periodic limits associated with one or more authorized account users. When a remote purchase transaction would exceed the available limit for a requesting user, including any associated overdraft margin, some form of override of the limit is sought, such as by explicit override approval or by allocation of at least a portion of the remote purchase transaction amount against another user's limit. If the limit remains, the remote purchase transaction is held until the beginning of a next period, when the transaction may be either automatically executed or submitted for reapproval by the requesting user.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a communications network in which a remote purchase monitoring and control system may be implemented according to one embodiment of the present invention;

FIG. 2 is a block diagram illustrating components of a remote purchase monitoring and control system according to one embodiment of the present invention; and

FIGS. 3A-3B are high level flowcharts for a process of remote purchase monitoring and control according to one embodiment of the present invention.

### DETAILED DESCRIPTION OF THE INVENTION

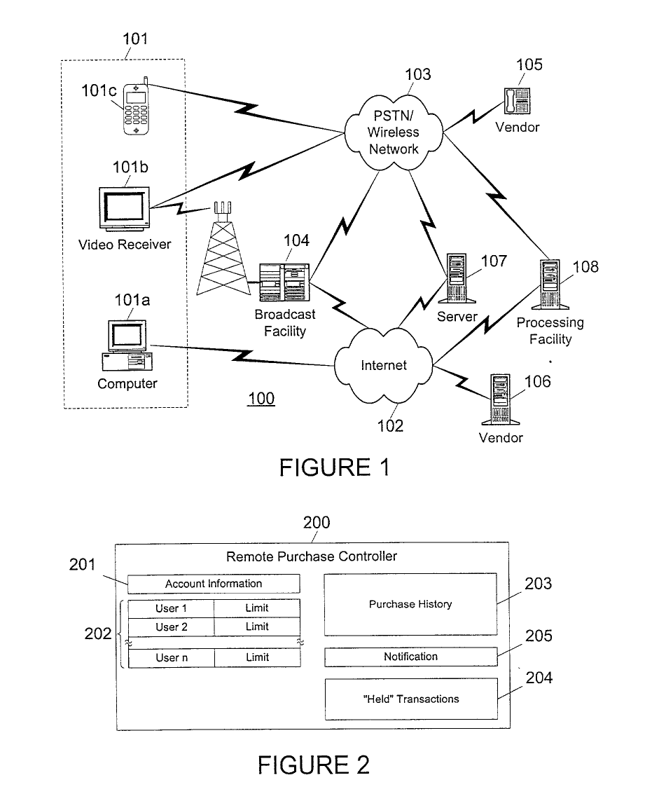

FIGS. 1 through 3A and 3B, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device.

FIG. 1 depicts a communications network in which a remote purchase monitoring and control system may be implemented according to one embodiment of the present invention. Communications network 100 includes a home access device 101 which may include: an Internet access device 101a such as a personal computer or set top box; a video receiver 101b such as a television, digital broadcast (satellite, terrestrial or cable) receiver, broadcast storage device such as a digital video cassette recorder (VCR) or magnetic disk recorder, or the like; a telephone, pager, text messaging device or combination device 101c, either landline or wireless; or any combination of such systems. Where home access device 101 includes multiple systems (e.g., a computer 101a and a video receiver 101b), such systems may be interconnected and operate in a coordinated fashion.

Home access device 101 is coupled to one or more communications systems such as the Internet 102 and/or a telephone network 103, which may comprise a public switched telephone network (PSTN), a wireless network (for voice communications, pages, text messages, or some mixture of the three), or some combination thereof. Home access device 101 may also be capable of demodulating programming from broadcast facility 104 and communicating with broadcast facility 104 via, for example, telephone network 103.

Home access device 101 is employed by the user to make remote purchases (e.g., “home shopping”) in which at least the order and payment portions of the purchase transaction are performed via communications systems 102 and/or 103. Purchased services (e.g., “pay-per-view” programming or Web site access) may be delivered via one or more of the communications systems 102 and 103, or from broadcast facility 104. Purchased goods are typically delivered separately via the United States mail or other commercial parcel delivery service.

Vendors from which the user makes purchases will generally have facilities such as telephone banks 105 or

Internet servers 106 coupled to one or both of communications systems 102 and 103, and may commission programming transmissions (e.g., “infomercials”) from broadcast facility 104. Communications network 100 also includes, in the exemplary embodiment, a server 107 optionally providing or facilitating remote purchase monitoring and control to the user of home access device 101 and a payment processing facility 108 for completing electronic payment transactions, both coupled to one or both of communications systems 102 and 103. A remote purchase monitoring and control system, described in further detail below, is implemented within communications network 100.

FIG. 2 is a block diagram illustrating components of a remote purchase monitoring and control system according to one embodiment of the present invention. Remote purchase controller 200 is implemented either within home access device 101, on a server 107 coupled to home access device 101, or in distributed fashion (either client-server or peer-to-peer) on both home access device 101 and server 107. Within home access device 107, remote purchase controller 200 may include modules on both Internet access device 101a and video receiver 101b, preferably operating in coordinated fashion with each other as well as with any portion of remote purchase controller 200 on server 107.

Any portion of remote purchase controller 200 within home access device 101 is preferably integrated with the control functionality for home access device 101. For example, remote purchase controller 200 may include a client functionality integrated within a browser on Internet access device 101a or within control software for video receiver 101b. Alternatively, remote purchase controller 200 may take the form of a “plug-in” or similar discrete program operating in collaboration with other functionality for home access device 101.

Operation of remote purchase controller 200 is triggered by detection of an attempt to complete a remote purchase. Such attempts may be detected, for example, by a user invoking remote purchase controller 200 to supply payment information, such as credit card or other account information 201, in connection with requesting a remote purchase. Account information 201 stored within remote purchase controller 200 is preferably not displayed to the user except when being entered or modified by an authorized individual. In facilitating remote purchases, account information 201 is preferably transmitted to the vendor facilities 105/106 or processing facility 108 without being displayed or otherwise communicated to the user.

Attempts to complete remote purchases might alternatively be detected by determining, while monitoring user input, that account information 201 has been entered by the user, or by a notification from processing facility 108 triggered by submission of the account information by a vendor to the processing facility 108 for approval or other processing of an electronic transaction on the corresponding account. Actuation of a “Buy”, “Submit” or “OK” control within a user interface may also trigger operation of remote purchase controller 200, as could any of these and other similar or related actions taken individually or in combination.

Upon detecting an attempt to complete a remote purchase, remote purchase controller 200 determines whether a budget or limit for the user would be exceeded. Multiple users 202 may be authorized to make purchases on the account identified by account information 201. For example, parents may set up their children as authorized users, with the children subsequently able to complete remote purchases with remote purchase controller 200 while the account information 201 is never disclosed to the children. Each user may have a corresponding limit, which may be an absolute limit or a time-dependent (e.g., monthly) limit. The limits for all users 202 are set, modified, or overridden by one or more users having such ability specifically enabled when the account information 201 is entered, or at a subsequent time by a user already having such ability enabled (or given special authority to modify other users).

Users 202 are identified by a unique identifier, such as a login name or fingerprint, facial characteristics or other biometric identifier, which may additionally have associated therewith contact information, such as an e-mail address, instant messaging address, or mobile phone or pager number. The limits associated with each user 200 may also have additional features set, such as a notification threshold (i.e., amount of limit at which the corresponding user is notified that the limit is being approached), positive or negative carry-forward (ability to accumulate unspent amounts or excess spending across multiple budget periods to either effectively “save” and increase the associated limit or “borrow” against the next period's budgeted amount), and “over-draft” amount (amount by which user may exceed limit within a given period). The carry-forward and over-draft features provide some elasticity to the limits. A running sum of amounts spent by each user for a current period may also be maintained in association with the user identifier(s).

Remote purchase controller 200 tracks all remote purchases by each of the users 202 within purchase history 203, including at least the user, date and amount for each remote purchase transaction, and preferably including an identification of the vendor and goods or services for each remote purchase transaction. Purchase history 203 is employed to determine when a user is approaching or will exceed a corresponding remote purchase limit. Either a running sum is maintained for each user during each period, or the transactions are reviewed upon each remote purchase attempt to identify previous purchases by the user within the current period to determine an amount spent to-date within the current period by that user.

Purchase history 203 may also be utilized to provide collated spending information on a periodic (e.g., monthly) basis by either generating a report, electronic or print, for transmittal to the user (together with the cable or satellite bill, Internet access bill, or telephone bill, for instance). When bills are reviewed by a household member, the expenditures are accessible in a handy, sensible place.

One or more users 202 may also be given the ability to review the purchase history 203 upon request, sorted and presented, for example, either by user, by period, by amount (total per user or by individual remote purchase), or by vendor. Each user is preferably given the ability to review the portions of purchase history 203 relating to remote purchases by that user, and one or more users may also be given the ability to review portions of the purchase history 203 relating to remote purchase by the remaining users or by other specified users 202.

If a requested remote purchase will not cause the requesting user to (excessively) exceed their limit, remote 110 purchase controller 200 facilitates the remote purchase by providing account information 200 to vendor facilities 105/106 or to payment processing facility 108. As noted above, account information 200 includes credit, debit, or check card numbers and associated cardholder information (name and billing address) and expiration dates, an account number and personal identification number (PIN) for electronic withdrawals, or similar electronic payment information such as. Encryption of account information 200 during transmission is preferred for security purposes, and transmission without display to the user (even the user which entered the account information 200) is also preferred.

In completing a remote purchase, remote purchase controller 200 may simply complete the purchase and log the transaction information within purchase history 203, or may alternatively present the requesting user with a summary of previous transactions by that user during the current period, together with the limit amount and overdraft margin if appropriate. Such a summary may be presented before completing the remote purchase, to allow or require the respective user to “approve” the purchase request, or after completing the purchase to inform the respective user of the status of the associated limit, or both.

If remote purchase controller 200 determines that a requested remote purchase would cause the requesting user to exceed their limit (either absolutely and/or with the over-draft margin), the remote purchase is not immediately completed by remote purchase controller 200. Depending on user-defined setting for the corresponding user, remote purchase controller 200 may simply ignore or discard the requested remote purchase transaction, or the requested remote purchase transaction may be “held” (within held transactions list 204) pending a limit override approval by another user 202 or for completion during a subsequent period.

One or more users 202 may be given authority to override, for an individual remote purchase transaction or during a particular period, the limit associated with another user. In this regard, notification information 205 (an e-mail or instant messaging address or phone number) may be directly employed by the remote purchase controller 200 to seek override approval for a requested remote purchase transaction, or may be provided to a vendor or payment processing enterprise with an appropriate message so that the respective user may be contacted to enter an override approval within remote purchase controller 200.

Alternatively, held transactions 204 may be simply held for processing during the first day of the next period, or for submission when the user accumulates a sufficient budgeted amount. A user may be enabled to customize each held transaction for automatic processing during the next period or when the user's limit exceeds the purchase amount, or for presentation to the corresponding user during the next period or once the purchase amount is available to that user so that the user may reconsider whether to make the requested remote purchase. Held transactions 204 may also be accessible for review by one or more other specified users, which may also have the ability to override the requesting user's limit or have the purchase amount “charged” against the reviewing user's own limit.

Similarly, one or more subsets of users 202 may be given the ability to pool or “share” the respective limits or budgeted amounts. Users within the subset may be given the ability to customize whether sharing is to be automatically allowed, or only upon notification and approval by the user whose limit is to be shared. Users may also be given the ability to reserve specific amounts or portions of the total associated limit from being shared, or particular periods or portions of periods during which sharing is precluded. Shared portions of one user's limit may be automatically “repaid” from the “borrowing” user's limit when the budgeted amounts are reset for the next period.

As a specific example, a family of four might use remote purchase controller 200 to budget and control spending on remote purchases, with the parents being collectively allocated an absolute limit of $300 per month and each of the children being allocated $30 per month with an over-draft margin of $5. If one child, having already used $27 of her budgeted amount within a particular month and having only $9 available (due to a prior month's positive carry-forward) wishes to purchase a compact disc costing $15.99 plus shipping, remote purchase controller 200 will not immediately complete the transaction since the purchase price exceeds the available limit plus over-draft margin.

Remote purchase controller 200 may first present the user requesting the purchase with a summary of previous purchases for the month, either automatically regardless of whether the user's limit and over-draft margin will be exceeded by the requested purchase or only when the user's limit and over-draft margin will be exceeded. The user may be given the opportunity to cancel or affirm the purchase request.

If a purchase request which would exceed the user's limit and over-draft margin is affirmed, remote purchase controller 200 may next notify one or both of the parents, who may either override the limit for their daughter for the specific requested purchase or allow the purchase price for the transaction to be (fully or partially) allocated to their limit.

If neither action is taken (either within a predetermined period or by being affirmatively declined) by both parents, remote purchase controller 200 may then notify the brother of the user requesting the remote purchase, with whom the user requesting the purchase has a limit sharing arrangement. The brother may actively approve or decline his sister's “borrowing” from his limit, or may have specified that only up to $10 of his limit could be borrowed, and only during the last week of a given month.

If the parents decline to override the limit or share the purchase price and the brother declines to “loan” his sister a portion of his limit, the transaction may then be simply held (either automatically or upon the requesting user's approval) by remote purchase controller 200 until the first day of the next month. At that time, remote purchase controller 200 may simply automatically complete the transaction (assuming the available limit balance is sufficient), or may remind the user of the purchase request by e-mail or instant message, allowing or requiring the user to cancel or affirm the requested purchase. If affirmed, remote purchase controller 200 completes the requested purchase.

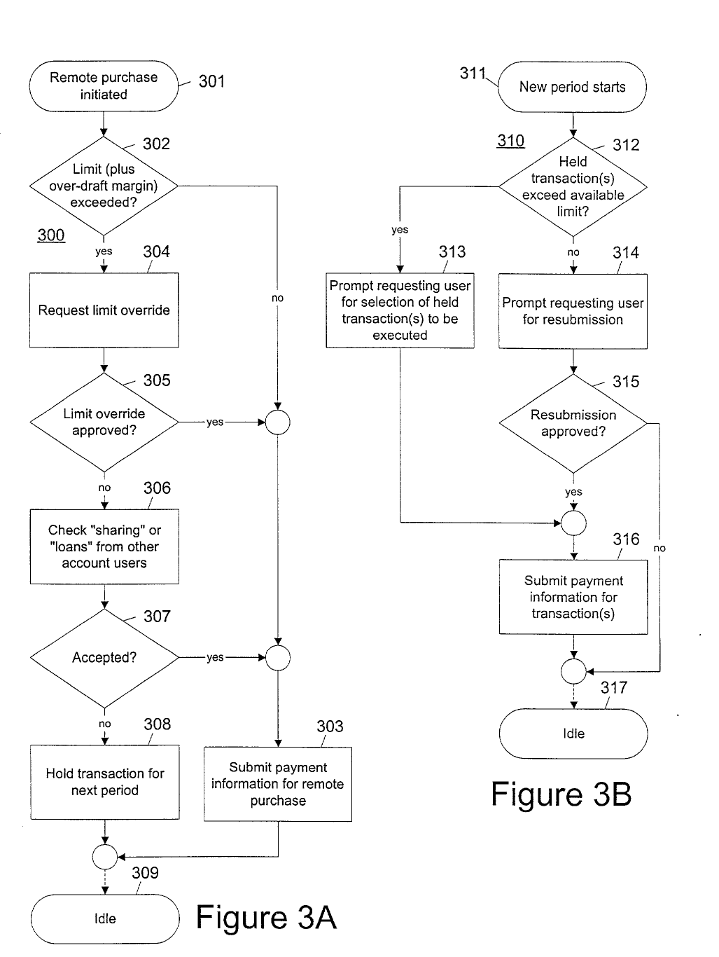

FIGS. 3A and 3B are high level flowcharts for a process of remote purchase monitoring and control according to one embodiment of the present invention. The process illustrated is performed by a remote purchase controller executing within a home access device, a remote purchase server, or a combination thereof. The process portion 300 depicted in FIG. 3A begins with initiation of a remote purchase employing an electronic payment account controlled by the remote purchase controller (step 301).

The process first determines whether the requested remote purchase would result in the requesting user exceeding an associated limit (step 302). If not, the account information is submitted for processing of electronic payment relating to the requested remote purchase (step 303). If so, however, an override of the requesting user's limit is requested (step 304), if such overrides are possible.

If no limit override is available or approved (step 305), a check is made for “sharing” of the remote purchase transaction amount by another authorized user of the account, or a “loan” from another authorized user of the account, which would permit at least a portion of the remote purchase transaction amount to be allocated against another user's limit (step 306). If no such sharing or loan is accepted (step 307), either automatically based on predefined criteria or affirmatively by the other user, the requested purchase transaction is held until the next period (step 308), when the requesting user's limit is reset or increased. The process then becomes idle (step 309) until another remote purchase is initiated.

The process portion 310 depicted in FIG. 3B begins with a new period starting (step 311), such as the first day of a new month within a given year. The process first determines whether the amounts for any held transaction(s), which are assumed to have been reinitiated by the remote process controller to determine current pricing, exceed the available limit for the requesting user (step 312). If so, the requesting user is prompted to select which, if any, of the remote purchases should be executed given the available balance for the requesting user (step 313). Individual transactions which still exceed the user's limit by themselves may be “grayed out” against user selection, except for deletion.

If the held transaction amount does not exceed the user's limit, the user may optionally be prompted to reapprove or resubmit the remote purchase, affirming a continued desire to execute the remote purchase (step 314). If resubmission is not approved (step 315), the transaction is optionally discarded. Otherwise, account information for electronic payment relating to the remote purchase is transmitted by the remote purchase controller (step 316), and the process becomes idle (step 317) until the start of the next period.

The present invention permits flexible control over remote purchases utilizing an electronic payment account such as a credit card. In particular, remote purchases which would currently exceed an associated limit may be held for processing during a subsequent period, after the associated limit has been reset or otherwise increased.

It is important to note that while the present invention has been described in the context of a fully functional communications network, home access device and/or server, those skilled in the art will appreciate that at least portions of the mechanism of the present invention is capable of being distributed in the form of a machine usable medium containing instructions in a variety of forms, and that the present invention applies equally regardless of the particular type of signal bearing medium utilized to actually carry out the distribution. Examples of machine usable mediums include: nonvolatile, hard-coded type mediums such as read only memories (ROMs) or erasable, electrically programmable read only memories (EEPROMs), recordable type mediums such as floppy disks, hard disk drives and compact disc read only memories (CD-ROMs) or digital versatile discs (DVDs), and transmission type mediums such as digital and analog communication links.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system for monitoring and controlling remote purchases comprising:
a home access device selectively coupled to at least one communications system; and
a remote purchase controller controlling remote purchases over the at least one communications network involving the home access device, the remote purchase controller:
responsive to detecting an attempt to execute a remote purchase transaction, determining whether the remote purchase transaction should be completed based upon a remote purchase limit; and
responsive to determining that the remote purchase transaction should not be completed, holding the remote purchase transaction for processing during a subsequent period.

2. The system of claim 1 wherein the remote purchase controller, in determining whether the remote purchase transaction should be completed based upon the remote purchase limit, determines whether the remote purchase transaction involves an amount exceeding a remaining available balance of the remote purchase limit for a current period.

3. The system of claim 2 wherein the remote purchase controller, in determining whether the remote purchase transaction should be completed based upon the remote purchase limit, identifies which of a plurality of authorized users associated with an account to be employed in the remote purchase transaction is attempting to execute the remote purchase transaction and ascertains the remaining available balance of the remote purchase limit for the identified user for the current period.

4. The system of claim 3 wherein the remote purchase controller, in response to determining that the remote purchase transaction involves an amount exceeding the remaining available balance of the identified user's remote purchase limit for the current period,
determines whether the remote purchase transaction amount exceeds the remaining available balance of the identified user's remote purchase limit for a current period plus an over-draft margin associated with the identified user's remote purchase limit,
seeks an override of the remote purchase limit for the current period or for the remote purchase transaction, and
determines whether another of the plurality of authorized users will permit a portion of the remote purchase transaction amount to be allocated against a remaining available balance for the current period of a remote purchase limit for the other user.

5. The system of claim 1 wherein the remote purchase controller automatically submits the remote purchase transaction for completion during the subsequent period.

6. The system of claim 1 wherein the remote purchase controller prompts a user initiating the remote purchase transaction for resubmission of the remote purchase transaction during the subsequent period.

7. The system of claim 1 wherein the home access device includes one or more of an Internet access device and a video receiver and wherein the remote purchase controller executes within the home access device.

8. A home access device for monitoring and controlling remote purchases comprising:
a communications connection to at least one communications system; and
a remote purchase controller controlling remote purchases over the at least one communications network involving the home access device, the remote purchase controller:
responsive to detecting an attempt to execute a remote purchase transaction, determining whether the remote purchase transaction should be completed based upon a remote purchase limit; and
responsive to determining that the remote purchase transaction should not be completed, holding the remote purchase transaction for processing during a subsequent period.

9. The home access device of claim 8 wherein the remote purchase controller, in determining whether the remote purchase transaction should be completed based upon the remote purchase limit, determines whether the remote purchase transaction involves an amount exceeding a remaining available balance of the remote purchase limit for a current period.

10. The home access device of claim 9 wherein the remote purchase controller, in determining whether the remote purchase transaction should be completed based upon the remote purchase limit, identifies which of a plurality of authorized users associated with an account to be employed in the remote purchase transaction is attempting to execute the remote purchase transaction and ascertains the remaining available balance of the remote purchase limit for the identified user for the current period.

11. The home access device of claim 10 wherein the remote purchase controller, in response to determining that the remote purchase transaction involves an amount exceeding the remaining available balance of the identified user's remote purchase limit for the current period,
determines whether the remote purchase transaction amount exceeds the remaining available balance of the identified user's remote purchase limit for a current period plus an over-draft margin associated with the identified user's remote purchase limit,
seeks an override of the remote purchase limit for the current period or for the remote purchase transaction, and
determines whether another of the plurality of authorized users will permit a portion of the remote purchase transaction amount to be allocated against a remaining available balance for the current period of a remote purchase limit for the other user.

12. The home access device of claim 8 wherein the remote purchase controller automatically submits the remote purchase transaction for completion during the subsequent period.

13. The home access device of claim 8 wherein the remote purchase controller prompts a user initiating the remote purchase transaction for resubmission of the remote purchase transaction during the subsequent period.

14. The home access device of claim 8 wherein the home access device includes one or more of an Internet access device and a video receiver and wherein the remote purchase controller executes within the home access device.

15. A method for monitoring and controlling remote purchases comprising:
responsive to detecting an attempt to execute a remote purchase transaction, determining whether the remote purchase transaction should be completed based upon a remote purchase limit; and
responsive to determining that the remote purchase transaction should not be completed, holding the remote purchase transaction for processing during a subsequent period.

16. The method of claim 15 wherein the step of determining whether the remote purchase transaction should be completed based upon the remote purchase limit further comprises:
determining whether the remote purchase transaction involves an amount exceeding a remaining available balance of the remote purchase limit for a current period.

17. The method of claim 16 wherein the step of determining whether the remote purchase transaction should be completed based upon the remote purchase limit further comprises:
identifying which of a plurality of authorized users associated with an account to be employed in the remote purchase transaction is attempting to execute the remote purchase transaction; and
ascertaining the remaining available balance of the remote purchase limit for the identified user for the current period.

18. The method of claim 17 wherein wherein the step of determining whether the remote purchase transaction should be completed based upon the remote purchase limit further comprises:
upon determining that the remote purchase transaction involves an amount exceeding the remaining available balance of the identified user's remote purchase limit for the current period,
determining whether the remote purchase transaction amount exceeds the remaining available balance of the identified user's remote purchase limit for a current period plus an over-draft margin associated with the identified user's remote purchase limit,
seeking an override of the remote purchase limit for the current period or for the remote purchase transaction, and
determining whether another of the plurality of authorized users will permit a portion of the remote purchase transaction amount to be allocated against a remaining available balance for the current period of a remote purchase limit for the other user.

19. The method of claim 15 further comprising:
automatically submitting the remote purchase transaction for completion during the subsequent period.

20. The method of claim 15 further comprising:
prompting a user initiating the remote purchase transaction for resubmission of the remote purchase transaction during the subsequent period.
